(19) United States
(12) Patent Application Publication
(10) Pub. No.: US 2005/0284026 A1
(43) Pub. Date: Dec. 29, 2005

(54) Shutter drive and lock assembly

(76) Inventors: Monty C. DuBose, Mt. Pleasant, SC (US); William McCaw Howe, Mt. Pleasant, SC (US)

Correspondence Address: KATHLEEN M HARLESTON;THE HARLESTON LAW FIRM, 909 TALL PINE ROAD, MT PLEASANT, SC, 29464, US

(21) Appl. No.: 11/167,817

(22) Filed: Jun. 27, 2005

Related U.S. Application Data
(60) Provisional application No. 60/583,042, filed on Jun. 25, 2004.

(51) Int. Cl. E05F 11/00

(52) U.S. Cl. 49/360

(57) ABSTRACT

A drive and lock assembly for driving a window shutter includes: (a) a first rail assembly including a slidable slide rail, the slide rail being attachable to the window shutter panel; (b) a first drive assembly including a rotatable drive shaft and a drive wheel, the rotatable drive wheel being attached to a first end of the drive shaft, the drive wheel contacting the slide rail; and (c) a mounting bracket assembly for mounting the drive shaft, the drive shaft extending through an aperture in a mounting bracket of the mounting bracket assembly adjacent the drive wheel; wherein the first drive assembly actuates movement of the drive wheel and therefore the slide rail, thereby moving the shutter panel between an open position and a closed position.

### CROSS REFERENCE TO RELATED DOCUMENT

Benefit is claimed under 35 USC 119(e) of provisional U.S. patent application No. 60/583,042, filed on Jun. 25, 2004.

### BACKGROUND OF THE INVENTION

1. Technical Field

The present invention relates to a mechanical assembly for actuating linear movement of an object and, more particularly, a mechanical assembly for opening and closing and locking hurricane shutters or the like.

2. Background Information

In coastal areas that are frequently subjected to the threat of an approaching hurricane, homeowners and business owners often install hurricane shutters to protect glass windows or doors. It is known that glass windows or doors may shatter upon impact with an object propelled by the winds of a hurricane, subjecting the building's interior space to wind and water damage. Many homeowners and business owners employ hurricane shutters because they are more convenient than securing plywood over window openings, particularly since time is often tight when a hurricane is approaching the coast. Hurricane shutters are permanently affixed to a building and need only be opened and closed, while plywood must be attached as the hurricane approaches, and then detached after the hurricane or hurricane threat is over. Also, plywood supplies at local stores are often depleted as the hurricane approaches and homeowners rush to the stores to purchase plywood. There are several different types of commercially available hurricane shutters, including roll-down shutters, Bahamas shutters, colonial shutters, accordion shutters, and storm panels, each of which is discussed below.

Roll-down shutters have many connected slats. When it is not in use, the roll-down shutter can be rolled up for storage into a box mounted above a window. The slats, guided by tracks, roll vertically down to cover the window. The position of roll-down shutters is ordinarily changed from inside the building. Roll-down shutters may be manually operated with a hand crank, or automatically operated by an electric motor. Unfortunately, roll-down shutters are often expensive to purchase.

Bahamas shutters form attractive awnings when they are open. A hinge attaches a top edge of the Bahamas shutter to an exterior face of a building immediately above a window opening, so the shutter pivots towards and away from the window. Telescoping side arms hold Bahamas shutters in position over the window. Bahamas shutters must be manually opened and closed from outside the building. This is sometimes inconvenient or strenuous, particularly for an older or disabled person.

Colonial shutters are mounted at the sides of a window and fold over the window. They must also be manually opened and closed from outside the building.

Accordion shutters have many connected panels that move horizontally along a lower track and an upper track. An accordion shutter made be any width, but its height is restricted according to the elevation at which it is hung. Accordion shutters are manually operated, can be fairly expensive, require frequent maintenance, and are not particularly aesthetically appealing.

Like plywood, storm panels are fastened over windows when a hurricane is imminent and stored during the rest of the year. Storm panels fit into tracks in window frames. Unfortunately, they require time-consuming outdoor installation (and later detachment), are usually heavy, and they require a substantial amount of storage space.

Roll-down shutters are expensive and the other types of shutters mentioned above also have various shortcomings. With the exception of roll-down shutters, all of these shutters must be manually operated from outside the building. Even if ground floor windows are manageable, outdoor manipulation of shutter mechanisms for second floor windows and above requires use of a ladder. The elderly and infirm in particular can have difficulty with hurricane shutters and the like, especially when they are anxious about the approaching storm. Thus, there is a need for an inexpensive and effective hurricane shutter assembly that is easy for lay people of any age to use and can be manipulated and locked from the inside of the home or other building.

The present invention allows easy opening and closing from the interior of the building the shutters are on. In fact, the present drive and lock assembly can be utilized in a variety of systems for moving an object in a linear direction.

### BRIEF SUMMARY OF THE INVENTION

The present invention is a drive and lock assembly for driving and locking a shutter panel of a window, the assembly comprising:

(a) a mounting for mounting the drive and lock assembly adjacent the window;

(b) a manually-operable first drive assembly comprising a rotatable drive shaft and a drive wheel, the drive shaft extending transversely through an upper end of the mounting, the drive wheel being rotatably attached to a first end of the drive shaft;

(c) a handle assembly, which is removably attached to a second, opposite end of the drive shaft; and

(d) a rail assembly comprising a slidable slide rail, the slide rail being attachable to the shutter panel;

wherein rotation of the handle assembly rotates the drive shaft, which rotates in turn the drive wheel, which moves the slide rail, which slides the shutter panel.

Also included herein is a shutter panel drive and lock assembly, comprising:

(a) a first rail assembly comprising a slidable slide rail, the slide rail being attachable to the window shutter panel;

(b) a first drive assembly comprising a rotatable drive shaft and a drive wheel, the rotatable drive wheel being attached to a first end of the drive shaft, the drive wheel contacting the slide rail; and

(c) a mounting bracket assembly for mounting the drive shaft, the drive shaft extending through an aperture in a mounting bracket of the mounting bracket assembly adjacent the drive wheel;

wherein the first drive assembly actuates movement of the drive wheel and therefore the slide rail, thereby moving the shutter panel between an open position and a closed position.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1A is an exploded perspective view of a shutter drive and lock assembly according to the present invention, showing a rail assembly mounted at a bottom end of a window and a shutter panel;

FIG. 1B is an exploded perspective view of a shutter drive and lock assembly according to the present invention, showing an additional guiding rail assembly;

FIG. 1C is an exploded perspective view of a shutter drive and lock assembly according to the present invention, showing a rail assembly mounted at a top end of a window and a shutter panel;

FIG. 1D is an exploded perspective view of a shutter drive and lock assembly according to the present invention, showing positions of the carrier rail and the slide rail reversed;

FIG. 2 shows a perspective view of a slide rail of a shutter drive and lock assembly according to the present invention;

FIG. 3 shows a perspective view of a carrier rail of a shutter drive and lock assembly according to the present invention;

FIG. 4A is a perspective view of a rail assembly of a shutter drive and lock assembly according to the present invention, showing a slide rail mounted to a shutter panel and a carrier rail engaging the slide rail;

FIG. 4B is a perspective view of a rail assembly of shutter drive and lock assembly according to the present invention, showing a slide rail;

FIG. 4C is a perspective view of a rail assembly of a shutter drive and lock assembly according to the present invention, showing a carrier rail;

FIG. 4D is a perspective view of a rail assembly of a shutter drive and lock assembly according to the present invention;

FIG. 5 is a perspective view of two identical rail assemblies of a shutter drive and lock assembly according to the present invention;

FIG. 6 is a perspective view of a first drive assembly and a handle assembly of a shutter drive and lock assembly according to the present invention;

FIG. 7 is a perspective view of a pair of shutter panels with a shutter drive and lock assembly according to the present invention, shown in an open position and hidden by faux shutters;

FIG. 8 is a perspective view of a pair of shutter panels with of a shutter drive and lock assembly according to the present invention, shown in a closed position and covering a window;

FIG. 9 is a perspective view of a shutter drive and lock assembly according to the present invention, showing a rail assembly mounted at a bottom end of a shutter panel;

FIG. 10 is a perspective view of a crank assembly of a shutter drive and lock assembly according to the present invention; and

FIG. 11 is a perspective view of a well assembly of a motorized shutter drive assembly according to the present invention.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

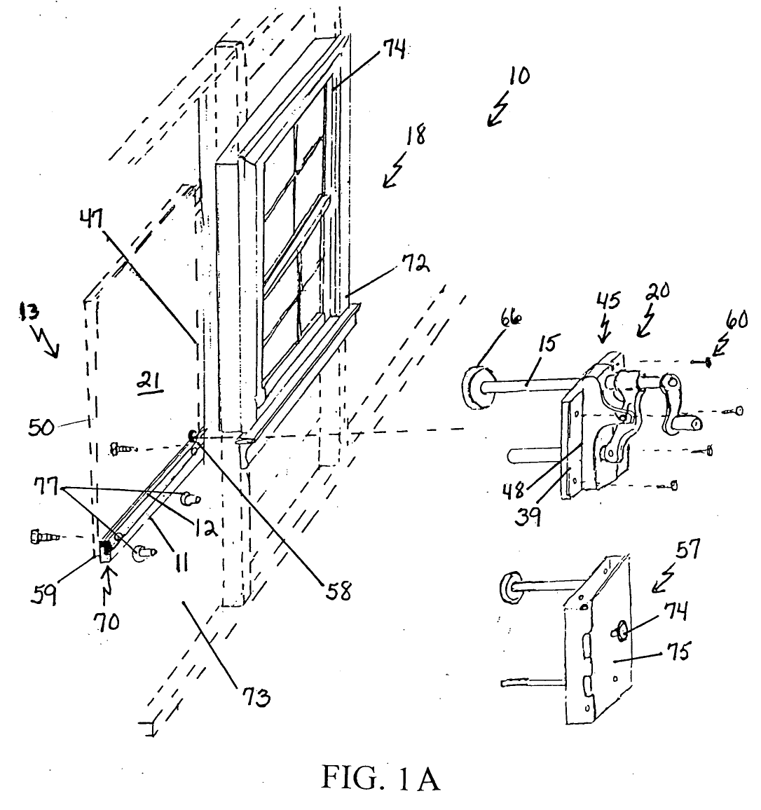

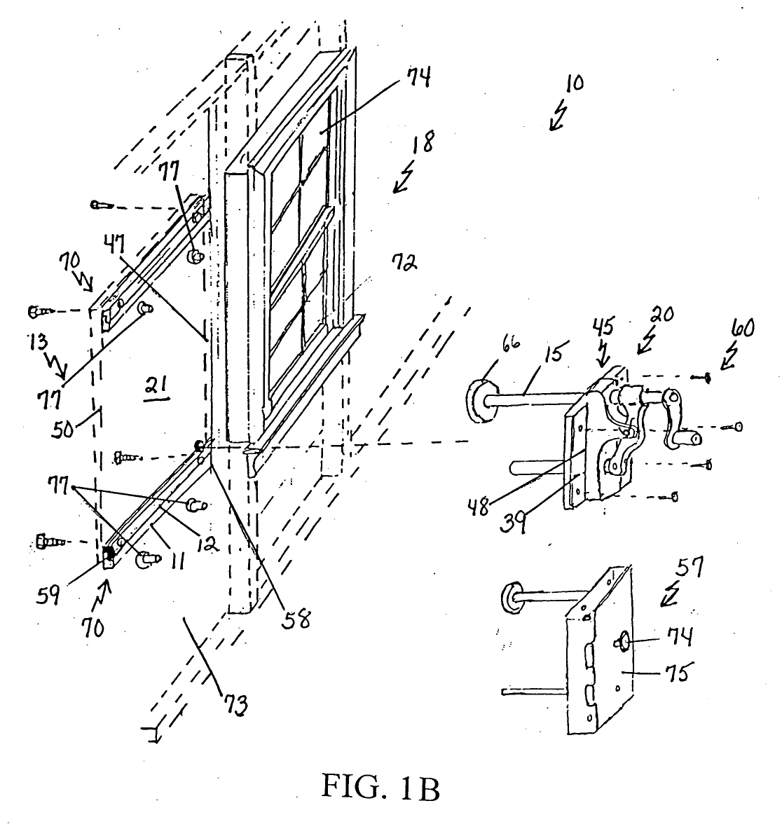

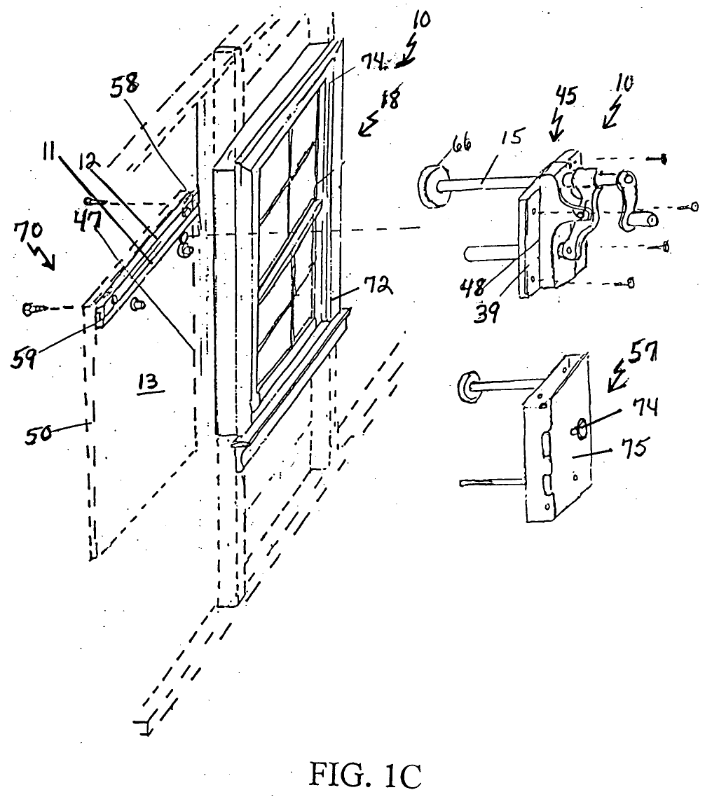

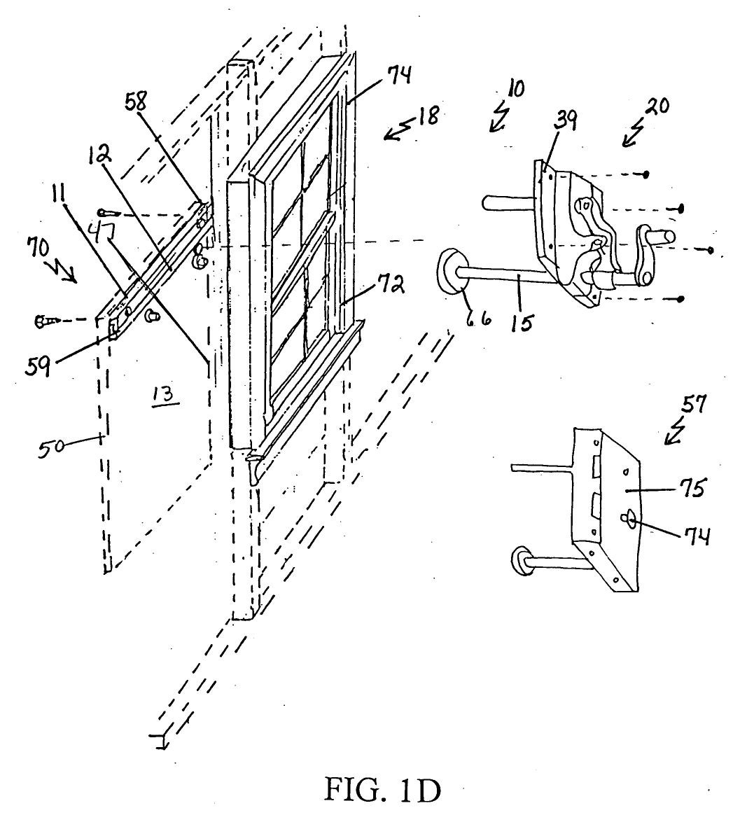

Turning first to FIG. 1A, a shutter drive and lock assembly according to the present invention, generally known as 10, comprises a shutter panel 13 movable between an open position, in which the shutter panel 13 rests adjacent to a window 18, and a closed position, in which the shutter panel 13 covers and protects the window 18. The shutter panel 13 is supported by a first rail assembly 70, which comprises a carrier rail 11 and a slide rail 12. The carrier rail 11 is mounted to an exterior face of a building adjacent to a bottom end 72 of the window 18. The slide rail 12 attached to the shutter panel 13 slides longitudinally along the carrier rail 11. A first drive assembly 20 actuates movement of the slide rail 12 on the carrier rail 11 and thus facilitates movement of the shutter panel 13 between the open and closed positions. Ordinarily, a window having two shutters will have two shutter drive and lock assemblies 10, one on each side of the window.

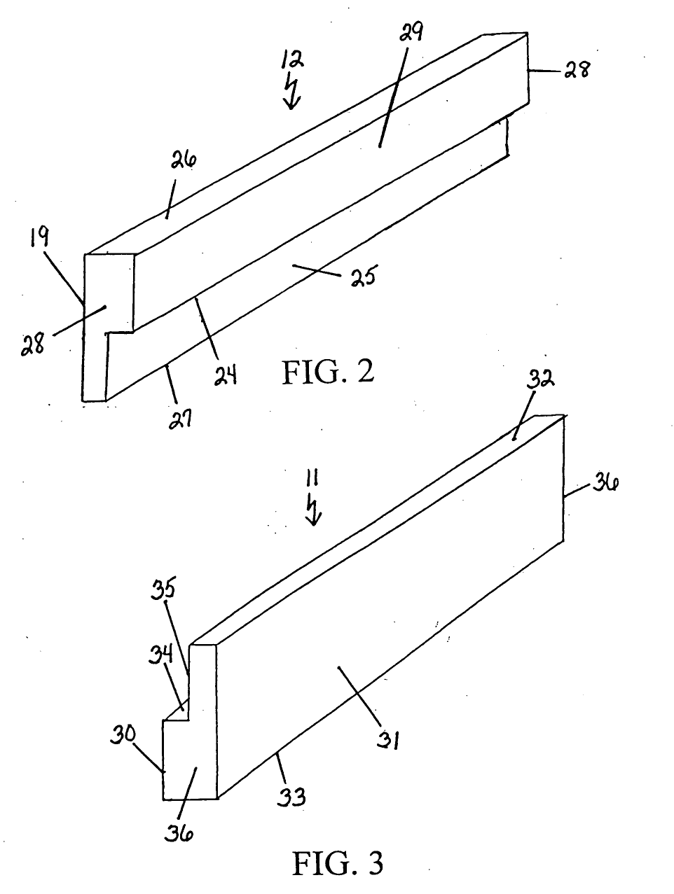

Referring to FIGS. 2 and 3, the carrier rail 11 and the slide rail 12 are both generally L-shaped in transverse cross-section. The slide rail 12 is similar to the carrier rail 11 in size and shape; however, in use the slide rail 12 is inverted so that it engages the carrier rail 11. The slide rail 12 comprises the following generally planar faces: a slide rail front face 19, a slide rail rear face 29, a slide rail top face 26, a slide rail bottom face 27, a slide rail first groove face 24, a slide rail second groove face 25, and slide rail end faces 28. The top face 26, bottom face 27, and first groove face 24 are spaced apart from and substantially parallel to each other. The front face 19, second groove face 25, and rear face 29 are spaced apart from and substantially parallel to each other and substantially perpendicular to faces 26, 27, and 24. The end faces 28 are spaced apart from and substantially parallel to each other and substantially perpendicular to faces 19, 29, 26, 27, 24, and 25. Similarly, the carrier rail 11 comprises the following generally planar faces: a carrier rail front face 30, a carrier rail rear face 31, a carrier rail top face 32, a carrier rail bottom face 33, a carrier rail first groove face 34, a carrier rail second groove face 35, and carrier rail end faces 36. The top face 32, bottom face 33, and first groove face 34 are spaced apart from and substantially parallel to each other. The front face 30, second groove face 35, and rear face 31 are spaced apart from and substantially parallel to each other, and substantially perpendicular to faces 32, 33, and 34. The end faces 36 are spaced apart from and substantially parallel to each other and substantially perpendicular to faces 30, 31, 32, 33, 34, and 35.

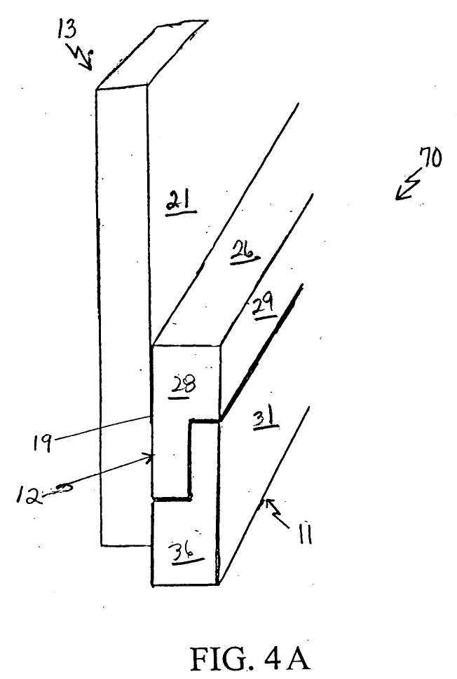

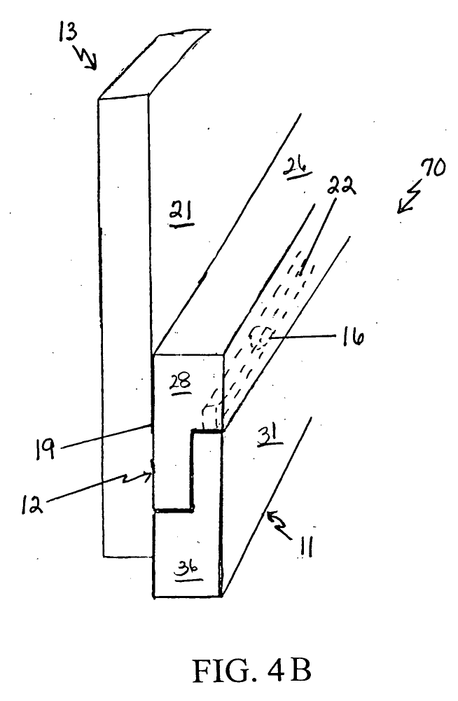

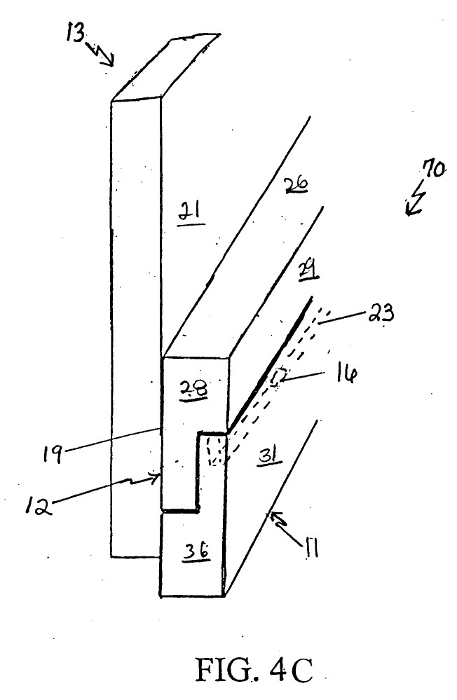

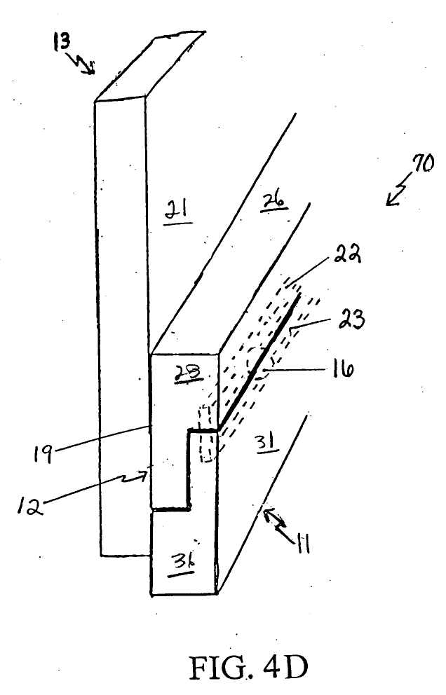

Referring now to FIG. 4A, the slide rail 12 is affixed to a shutter panel rear face 21 by screws, nails, glue, adhesive, or the like, so that the slide rail front face 19 contacts a rear face 21 of the shutter panel 13. Rails 11 and 12 mate with the following faces contacting each another: carrier rail first groove face 34 and slide rail bottom face 27, slide rail second groove faces 25 and carrier rail second groove face 35, and carrier rail top face 23 and slide rail first groove face 24, respectively. The slide rail 11 slides longitudinally along the carrier rail 12 to carry the shutter panel 13 between the closed position and the open position, and back again.

The rail assembly 70 shown in FIG. 4B further comprises a slide rail roller channel 22, which extends longitudinally along the generally downwardly facing slide rail first groove face 24. At least two rollers 16 are rotatably mounted in the channel 22 to ease and smooth the movement of the slide rail 12 on the carrier rail 11. Preferably, one roller 16 is mounted in the track 71 near an inner end 58 of the rail assembly 70, and another roller 16 is mounted in the track 71 near an outer end 59 of the rail assembly 70. During movement of the shutter panel 13 between the open and closed positions, the rollers 16 glide on the carrier rail top face 32 to reduce friction between the rails 11, 12.

In the rail assembly 70 shown in FIG. 4C, the carrier rail 11 instead comprises a carrier rail roller channel 23, which extends longitudinally along the generally upwardly facing carrier rail top face 32. The two rollers 16 are rotatably mounted in the channel 23 to ease and smooth the movement of the slide rail 12 on the carrier rail 11. During movement of the shutter panel 13 between the open and closed positions, the rollers 16 glide on the carrier rail top face 32 to reduce friction between the rails 11, 12.

Alternatively, FIG. 4D shows a rail assembly 70 comprising a pair of matching channels: the slide rail roller channel 22, and the carrier rail roller channel 23. These channels 22, 23 are aligned and create a track 71 that accommodates the two rollers 16. The rollers 16 ease and smooth the movement of the slide rail 12 on the carrier rail 11 by reducing friction between the rails 11, 12. The rollers 16 are weather and corrosion resistant, and are preferably made of nylon and stainless steel.

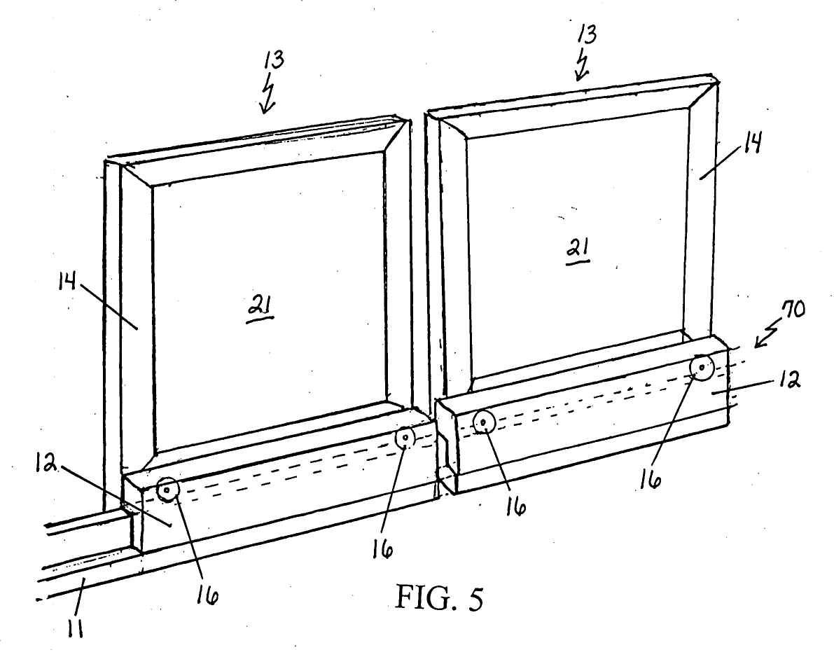

The carrier rail 11 and the slide rail 12 may be rotated 180 degrees on installation, so that the slide rail rear face 29, rather than the slide rail front face 19, is fastened to the shutter panel 13, as shown in FIG. 5. A frame 14 preferably surrounds the shutter panel 13, and the slide rail 12 is fastened to the frame 14. The frame 14 is preferably constructed from a polycarbonate material, and is preferably covered with a powdered aluminum coating.

Turning back to FIG. 1A, the first drive assembly 20 is contained within an enclosure, or box 57, mounted on the interior or exterior face of the wall 73 adjacent to the window 18. Thus, the shutter panel 13 may be moved between the open position and the closed position from the interior of the building rather than the exterior of the building. The first drive assembly 20 comprises a mounting 45 affixed to an interior of the box 57. A generally planar mounting face 48 contacts a rear wall 39 of the drive assembly box 57. The drive assembly box 57 comprises a hinged door 75 that may be opened to reveal the first drive assembly 20 or closed to conceal the first drive assembly 20.

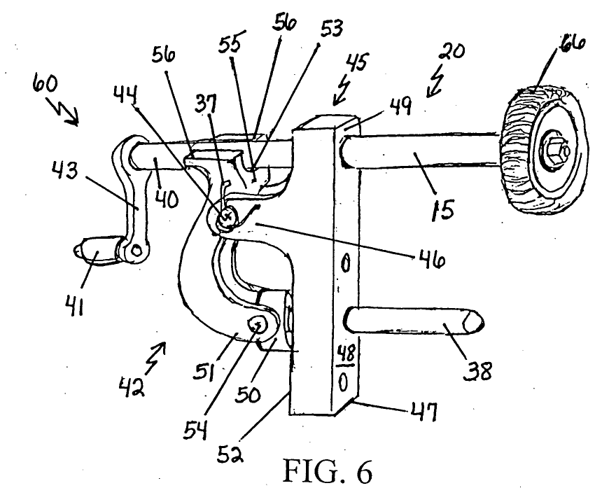

Referring to FIG. 6, a rotatable drive shaft 15 of the first drive assembly 20 extends transversely through a hole in the upper end portion 49 of the mounting 45, the rear wall 39 of the box, and the wall 73. A rotatable drive wheel 66 is attached to an end of the drive shaft 15. In use, the drive wheel 66 contacts the slide rail top face 26. Rotation of the drive wheel 66 moves the slide rail 12 and the attached shutter panel 13 away from or over the window 18 it covers.

Continuing with FIG. 6, a lock shaft 38 for maintaining the shutter panel 13 in the closed position or open position is also transversely extendible through a corresponding hole in the mounting 45, the rear wall 39 of the box, and the building wall 73. The lock shaft 38 lies below the drive shaft 15 and is translational through the mounting 45, rear wall 39, and building wall 73 along the shaft's longitudinal axis. When the lock shaft 38 is locked in place, it is generally parallel to the drive shaft. An end of the lock shaft 38 is pivotally mounted to a first end 51 of a lever arm 42. An opposite end of the lock shaft 38 is substantially unencumbered. The lever arm 42 is further pivotally attached at approximately its midpoint to a stationary pivot arm 46 that projects from a lever side 52 of the mounting 45. Thus, the first drive assembly 20 has two pivot points: a first pivot point 44 between the lever arm 42 and the pivot arm 46, and a second pivot point 54 between the lever arm 42 and the lock shaft 38. The lever arm 42 is spring-loaded at pivot point 44 by a spring 37.

Still referring to FIG. 6, the drive shaft 15 extends past the lever side 52 of the mounting 45 and through a channel 53 in the lever arm 42. The lever arm channel 53 extends between two mirror image, spaced apart, generally parallel walls 56 projecting from a second end 55 of the lever arm 42. The end of the drive shaft 15 adjacent the channel 53 is unencumbered. Cranking of a handle assembly 60, which is removably attached to the free end of the drive shaft 15, actuates operation of the first drive assembly 20. The handle assembly 60 can be removed and stored when the drive and lock assembly 10 is not in use for aesthetic and safety reasons. The handle assembly 60 comprises a crank shaft 40, a handle bar 43, and a handle 41. An end of the crank shaft 40 is open, so that the crank shaft 40 may be inserted over the free end of the drive shaft 15 opposite the drive wheel 66. The handle bar 43 projects substantially perpendicularly from an opposite end of the crank shaft 40. The user-friendly handle 41 projects substantially perpendicularly from an end of the handle bar 43 opposite the crank shaft 40.

In order to drive the shutter panel 13 leftward or rightward along the rail assembly 70, a user inserts the crank shaft 40 over the drive shaft 15 and pushes the crank shaft 40 against the walls 56 of the lever arm 42. The force exerted by the user on the walls 56 pivots the lever arm 42 about pivot point 44 so that the second end 55 of the lever arm 42 abuts the lever side 52 of the mounting 45. As a result, the drive shaft 15 assumes an extended position, in which the drive wheel 39 rests on the slide rail top face 26.

Next, the user turns the handle assembly 60 either clockwise or counterclockwise. Turning the handle assembly 60 clockwise moves the shutter panel 13 to the open position, while turning the handle assembly 60 counterclockwise moves the shutter panel 13 to the closed position. Rotation of the handle assembly 60 rotates the drive shaft 15, which in turn rotates the drive wheel 66. As the drive wheel 66 rotates, it grips the slide rail 12, which causes the slide rail 12 to slide along the carrier rail 11. The slide rail 12 is preferably coated with a substance, such as sandpaper, that facilitates gripping and prevents the wheel from any skidding. When the drive shaft 15 is in its extended position, the lock shaft 38 is in a corresponding retracted position, where the end of the lock shaft 38 opposite the lever arm 42 is spaced apart from the slide rail 12 and carrier rail 11. Thus, the lock shaft 38 does not interfere with sliding of the slide rail 12 on the carrier rail 11. FIG. 1 shows the drive shaft 15 in its extended position and the lock shaft 38 in its retracted position.

One rotation of the rotatable handle of the handle assembly 60 equals one rotation of the drive wheel 66. Preferably, one rotation of the drive wheel 66 translates the shutter panel 13 several inches, so that the shutter panel 13 may be quickly and easily opened and closed by hand. Such an efficient hand first drive assembly 20 is advantageous; electrically aided (i.e., motorized) movement of the shutters panels is unnecessary. Most preferably, the drive wheel 66 is about 2.5 inches in diameter, and one rotation of the wheel moves the shutter panel 13 a little more than half that distance (more preferably between about 5.5 inches and about 6 inches). Thus, if the shutter panel 13 is about 18 inches wide, the shutter panel 13 may be moved between the open position and the closed position, or vice versa, in about 3.25 rotations of the handle assembly 60.

Once the shutter panel 13 is in the closed position or the open position, the user removes the crank shaft 40. Upon removal of the force exerted by the crank shaft 40 on the walls 56, the spring 37 returns the lever arm 42 to a default position, where the drive shaft 15 is in a retracted position and the lock shaft 38 is in an extended position. When the drive shaft 15 is in its retracted position, the drive wheel 66 no longer contacts the slide rail top face 26 and is spaced apart from the rail assembly 70. When the lock shaft 38 is in its extended position, it lies adjacent to and across an end of the slide rail 12. This prevents the slide rail 12 from moving either toward or away from the window 18 along the carrier rail 11.

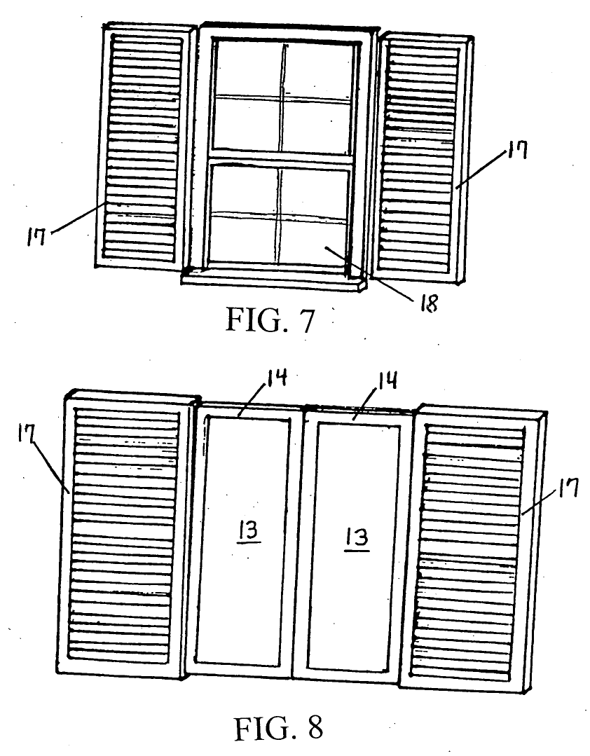

Turning back again to FIG. 1A, which depicts a right shutter panel 13 in the open position, the drive wheel 66 is adjacent to an inner side 47 of the shutter panel 13, and the lock shaft 38 is in its extended position and abuts an inner end 58 of the rail assembly 70. Thus, the lock shaft 38 prevents the shutter panel 13 from moving to the closed position. When the shutter panel 13 is in the closed position, as shown in FIG. 7, the drive wheel 66 is adjacent to an outer side 50 of the shutter panel 13 and the lock shaft 38 is in its extended position and abuts an outer end 59 of the rail assembly 70. Thus, the lock shaft 38 prevents the shutter panel 13 from moving to the open position.

Looking at FIGS. 7 and 8, which show shutter panels 13 in the open and closed positions, respectively, two shutter drive and lock assemblies 10 are installed in order to protect the entire window 18. The shutter drive and lock assembly 10 installed on the left side of the window 18 includes the shutter panel 13 that covers the left half of the window 18, while the shutter assembly 10 installed on the right side of the window 18 includes the shutter panel 13 that covers the right half of the window 18. Preferably, faux shutters 17 hung next to the window 18 conceal the shutter panels 13 when they are in the open position. When the shutter panels are in the closed position, they extend from the faux shutters 17 and cover the window 18. The faux shutters 17 also conceal the carrier rails 11.

Alternatively, the rail assembly 70 and first drive assembly 20 may drive the shutter panel 13 from its top end. The carrier rail 11 may be mounted to the exterior face of the wall 73 next to a top end 74 of the window 18, and the box 57 may be mounted to the interior face of the wall 73, as shown in FIG. 1C. Alternatively, the box may be mounted on the outside of the building nested in the facade, with the handle extending inside the building. The shutter drive and lock assembly 10 depicted in FIG. 1C operates in the same manner as the shutter drive and lock assembly 10 depicted in FIG. 1A. Also, the positions of the carrier rail 11 and the side rail 12 may alternatively be reversed as shown in FIG. 1D (i.e., the slide rail 12 may lie below the carrier rail 11 such that the drive wheel 66 travels along the slide rail face 26).

The shutter drive and lock assembly 10 may include another identical rail assembly 70 near the end of the window 18 and shutter panel 13 opposite the first rail assembly 70 for additional guidance and support of the shutter panel 13. FIG. 1B illustrates the rail assembly 70 driven by the drive wheel 26 mounted at the bottom end of the window 18 and shutter panel 13 and the guiding rail assembly 70 mounted at the top end of the window 18 and shutter panel 13. The second rail assembly 70 has a second slide rail 12 mounted to shutter panel 13 at its top end, and a second carrier rail 11 mounted to the exterior face of the wall 73 next to a top end 74 of the window 18.

A number of compression fittings 77 are affixed to the rail assemblies 70 and the window 18. The fittings 77 extend between the rail assemblies 70 and the window 18 when the shutter panels 13 are in the closed position. The compression fittings 77 act as shock absorbers and provide cushioning between the shutter panel 13 and the window 18. If an object hits the shutter panel 13, the compression fittings 77 absorb some of the force of the object's impact so that the entire force is not translated to the window 18. This reduces the likelihood of the window breaking or shattering. The compression fittings 77 are preferably made of rubber.

The rail assembly 70 and the first drive assembly 20, with the exception of the drive wheel 66, are preferably made of a non-corrosive material, such as stainless steel. The drive wheel 66 may be made of a nylon or rubber material. The carrier rail 11 is preferably covered with an anodized aluminum coating colored to match the window's framework. Preferably the shutter panels 13 are made from a material that blocks no more than about 30 percent of ambient light. This is advantageous in the event of a power outage, which is likely under hurricane or tropical storm conditions.

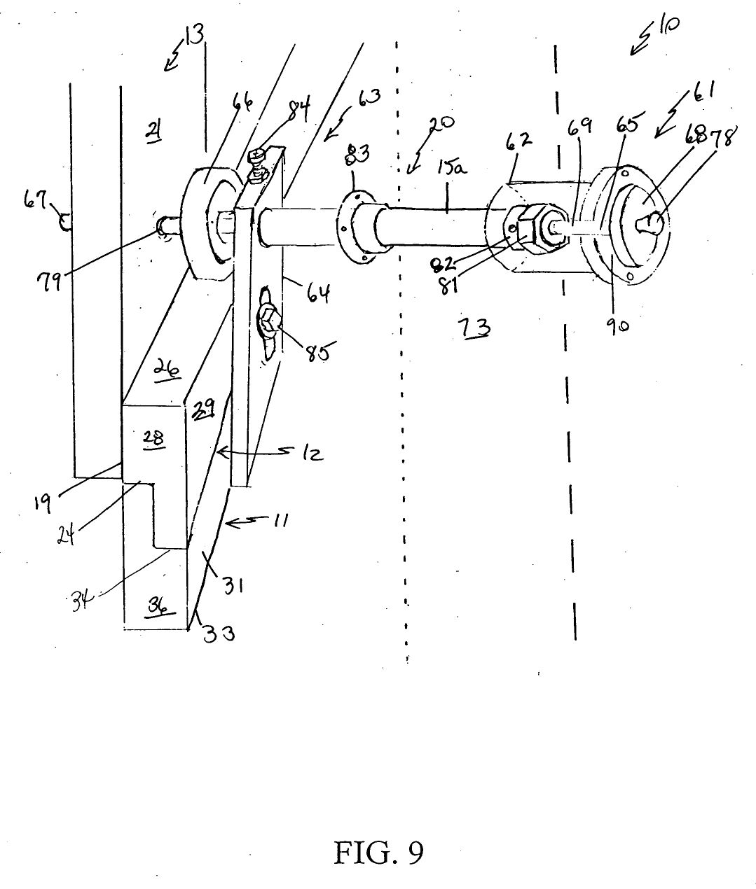

Turning now to FIGS. 9-11, a shutter drive and lock assembly 10 comprises a shutter panel 13 movable between the open position (see FIG. 7), in which the shutter panels rest in front of the window, and the closed position, in which the shutter panels 13 cover and protect the window (see FIG. 8). The shutter panel 13 is supported by the first rail assembly 70, a portion of which is depicted in FIG. 9.

The faux shutters 17 (shutter facades) may alternatively be glued to the front of the shutter panels 13, if the user does not like the appearance of the shutter panels 13 over the windows when the shutter panels are in the closed position. This is simply an aesthetic alternative to conceal the appearance of the shutter panels from passers by on the street side of the house or other building the shutter panels are on.

The first rail assembly 70 comprises a generally L-shaped carrier rail 11 and a similarly shaped slide rail 12. The carrier rail 11 is mounted to an exterior face of a building adjacent to a bottom end 72 of the window. The slide rail 12 attached to the shutter panel 13 slides longitudinally along the carrier rail 11. A first drive assembly 20 actuates movement of the slide rail 12 on the carrier rail 11 and thus facilitates movement of the shutter panel 13 between the open and closed positions. Ordinarily, a window having two shutters will have two shutter drive and lock assemblies 10, one on each side of the window.

Continuing with FIG. 9, the slide rail 12 is preferably-the same size and shape as the carrier rail 11, but the slide rail 12 is inverted so that it engages the carrier rail 11. As before, the slide rail 12 comprises a slide rail front face 19, a slide rail rear face 29, a slide rail top face 26, a slide rail bottom face 27, a slide rail first groove face 24, a slide rail second groove face 25, and slide rail end faces 28. The top face 26, bottom face 27, and first groove face 24 are substantially parallel to each other. The parallel front face 19, second groove face 25, and rear face 29 are substantially perpendicular to faces 26, 27, and 24. The parallel end faces 28 are substantially perpendicular to faces 19, 29, 26, 27, 24, and 25. Similarly, the carrier rail 11 comprises a carrier rail front face 30, a carrier rail rear face 31, a carrier rail top face 32, a carrier rail bottom face 33, a carrier rail first groove face 34, a carrier rail second groove face 35, and carrier rail end faces 36. The top face 32, bottom face 33, and first groove face 34 are substantially parallel to each other. The substantially parallel front face 30, second groove face 35, and rear face 31 are substantially perpendicular to faces 32, 33, and 34. The substantially parallel end faces 36 are substantially perpendicular to faces 30, 31, 32, 33, 34, and 35. The slide rail first groove face 24 of the slide rail 12 is slidable on the carrier rail first groove face 34 of the carrier rail 11.

As is also depicted in FIG. 9, the slide rail 12 is affixed to a shutter panel rear face 21 by screws, nails, glue, adhesive, or the like, with the slide rail front face 19 contacting the rear face 21 of the shutter panel 13. Rails 11 and 12 mate with the following faces contacting each another: carrier rail first groove face 34 and slide rail bottom face 27, slide rail second groove faces 25 and carrier rail second groove face 35, and carrier rail top face 23 and slide rail first groove face 24, respectively. In use, the slide rail 11 slides longitudinally along the carrier rail 12, carrying the shutter panel 13 between the closed position and the open position, and back again.

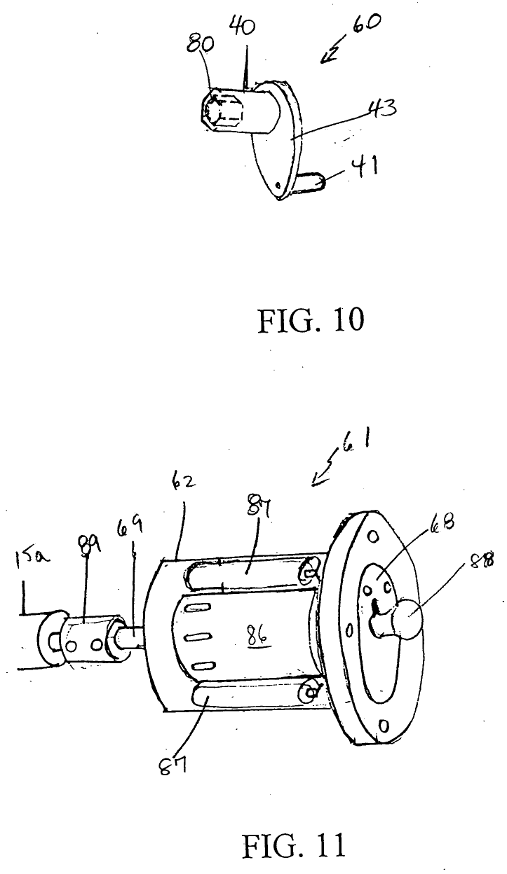

A handle assembly 60 of a shutter drive and lock assembly 10 is shown in FIG. 10. The handle assembly 60 is insertable into a well 62 of the well assembly 61 shown in FIG. 9.

The shutter drive and lock assembly 10 comprises a well assembly 61, the first drive assembly 20, and a mounting bracket assembly 63, as shown in FIG. 9, as well as the handle assembly 60 depicted in FIG. 10. The first drive assembly 20 comprises a locking rod 69 that extends through: a) the well 62 of the well assembly 61, b) then through the central bore in the drive shaft 15a, which extends through the building wall 73 (indicated by dashed lines in FIG. 9) adjacent the window, through an aperture in an upper end of a mounting bracket 64 of the mounting bracket assembly 63, and through a hole in the center of the drive wheel 66, and c) a hole 79 in the shutter panel 13. It has been found herein that the shutter panel hole can be drilled on installation by extending a drill bit through the hollow drive shaft 15a (without the locking rod) into the shutter panel 13 and drilling a hole 79 through the shutter panel 13 of sufficient size to accommodate the end 67 of the locking rod 69. This will assure that the hole 79 is correctly located. Ordinarily, a hole is drilled in both ends of a shutter panel, so the shutter panel 113 can be locked open or closed.

In this drive and lock assembly 10, the first end 65 of the locking rod 69 extends through the approximate center of the well 62 of the well assembly 61 and is affixed to a removable well cap 68 in the top opening 90 of the well. The second, opposite end 67 of the locking rod 69 extends through the shutter panel 13, as seen in FIG. 9.

As shown in FIGS. 9 and 11, the well cap 68 of the well assembly 61 preferably comprises a nipple 78 attached to the approximate center of its upper surface for the user to grasp. The user uses the nipple to pull the well cap 68 and its attached locking rod 69 out of the first drive assembly 20. The locking rod 69 is preferably made of stainless steel. The well 62 and well cap 68 are preferably made of a resilient plastic material, which may be transparent. When the locking rod 69 is in place, it extends into or through the shutter panel 13, so the shutter panel and the drive and lock assembly 10 cannot be moved. The shutter panel 13 is locked in place.

To move the shutter drive assembly, once the well cap 68 and locking rod 69 have been removed, the handle assembly 60 is inserted into the top opening 90 of the well 62. Operating the handle assembly 60, which is removably attached to the shaft 15a, actuates operation of the first drive assembly 20. The handle assembly 60 can be removed and stored when the drive and lock assembly 10 is not in use for aesthetic and safety reasons.

The handle assembly 60 comprises a crank shaft 40, a handle bar 43, and a rotatable handle 41, as shown in FIG. 10. A female recess 80, preferably hexagonal in shape, in the end of the crank shaft 40 closely corresponds to a male form 81, preferably a nut, on the end of the drive shaft 15a. The hexagonal-shaped recess 80 in the end of the crank shaft 40, which is shown in outline in FIG. 10, closely accommodates the nut 81 on the drive shaft 15a. In this preferred embodiment, the nut 81 is adjacent a collar 82 having a lock screw. The crank shaft 40 is insertable over the nut 79 on the end of the drive shaft 15a. The handle bar 43 projects down substantially perpendicularly from an opposite end of the crank shaft 40. The user-friendly handle 41 projects out substantially perpendicularly from an end of the handle bar 43 opposite the crank shaft 40.

A second collar 83 with a bushing encircles the driveshaft 15a below the nut 79 (see FIG. 9). The nut 79 locks the drive shaft 15a in place with thrust between the second collar 83. The second collar 83 provides support for the drive shaft 15a and the drive wheel 66. The well 62 also supports the drive shaft 15a, as well as the locking rod 69 when it is in place.

Next, the shaft 15a extends through the hole in the mounting bracket assembly 63, and then the hole 79 in the drive wheel 66. The mounting bracket assembly 63 comprises the mounting bracket 64 for the drive wheel 66, a mounting bracket tension bolt 84 with a lock nut preferably at the top of the mounting bracket where it is accessible, and a mounting bracket second bolt 85 for securing the mounting bracket 64 to the window frame. Turning the mounting bracket tension bolt 84 to the right pushes the drive wheel 66 down against the slide rail 12 for improved traction. This feature allows a user to increase tension on a loose drive wheel that is spinning in place on the slide rail. The rotatable drive wheel 66 is attached to the drive shaft 15a. In use, the drive wheel 66 rests upon the slide rail top face 26. Once the locking rod 69 has been removed, rotation of the drive wheel 66 moves the slide rail 12 and the attached shutter panel 13 away from or over the window 18. The drive wheel 66 is preferably made of a neoprene material. The locking rod 69 permits the shutter panel to be locked in the open or closed position.

In order to drive the shutter panel 13 leftward or rightward along the rail assembly 70, a user removes the locking rod 69 and inserts the crank shaft recess 80 over the nut 81 on the drive shaft 15a. The user then turns the handle 41. Rotation of the handle rotates the drive shaft 15a, which in turn rotates the drive wheel 66. As the drive wheel 66 rotates, it grips the slide rail 12, which causes the slide rail 12 to slide along the carrier rail 11.

One rotation of the handle 41 of the handle assembly 60 preferably corresponds to one rotation of the drive wheel 66. Preferably, one rotation of the drive wheel 66 translates the shutter panel 13 several inches so that the shutter panel 13 may be quickly and easily opened and closed by hand. Most preferably, the drive wheel 66 is between about two and three inches in diameter, and a single rotation of the drive wheel 66 moves the shutter panel 13 about twice that distance.

A substantial portion of the drive shaft 15a (from the bottom part of the well 62 to the mounting bracket 64) is within the wall 73 of the building on which the shutter panel 13 is mounted. The shutter panel 13 is of course on an exterior of the building wall 73. The well opening 90 is accessible from an interior room of the building. When the homeowner or other user is going on vacation, or fleeing a hurricane, for example, he or she can go from well 62 to well 62 of each drive/lock assembly 10 with the handle assembly 60 closing the shutter panels 13. When the well cap 68 is in place in the well 62, it presents an attractive appearance on the interior wall of the house and its presence discourages access to the well (e.g., by a child in the room). Once the locking rod 69 is removed, the drive assembly 10 can be operated and the shutter panel 13 can be moved.

This efficient hand-operated drive assembly 10 works well and does not require a motor for operation. However, a small motor can be employed herein for use by the elderly or infirm, for example, or simply for a homeowner in a hurry (e.g., where a hurricane looms). Referring to FIG. 11, the well assembly 61 further comprises a motor 86 operated by batteries 87. The motor 86 is preferably closely housed in the well 62. The motor 86 is operated by a switch 88 in the well cap 68. A 12 volt DC 300-600 rpm motor is preferably coupled by a coupling 89 to the drive shaft 15a. In use, the user moves the open/close switch 88 in an upward direction, for example, to turn on the motor, which automatically initiates rotation of the drive shaft 15a and therefore movement of the drive wheel 66. Since moving the switch 88 in a downward direction turns the motor 86 off, no movement occurs when the motor is not in operation, so no locking rod is necessary. A solenoid lock for electric drive is used in place of a locking rod.

From the foregoing it can be realized that the described device of the present invention may be easily and conveniently utilized as an assembly for driving and locking down exterior shutters. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### LIST OF REFERENCE NUMBERS USED IN THE DRAWINGS

10 shutter drive and lock assembly
11 carrier rail
12 slide rail
13 shutter panel
14 frame of panel
15 drive shaft
16 roller
17 faux shutters
18 window of building
19 slide rail front face
20 first drive assembly
21 shutter panel rear face
22 slide rail roller channel
23 carrier rail roller channel
24 slide rail first groove face
25 slide rail second groove face
26 slide rail top face
27 slide rail bottom face
28 slide rail end face
29 slide rail rear face
30 carrier rail front face
31 carrier rail rear face
32 carrier rail top face
33 carrier rail bottom face
34 carrier rail first groove face
35 carrier rail second groove face
36 carrier rail end face
37 spring of lever arm
38 lock shaft
39 rear wall
40 crank shaft
41 handle
42 lever arm
43 handle bar
44 first pivot point
45 mounting
46 pivot arm
47 inner side
48 mounting face
49 upper end of mounting
50 outer side
51 first end of lever arm
52 lever side
53 channel in lever arm
54 second pivot point
55 second end of lever arm
56 wall of lever arm
57 box of drive assembly
58 inner end of rail assembly
59 outer end of rail assembly
60 handle assembly
61 well assembly
62 well
63 mounting bracket assembly
64 mounting bracket
65 first end of locking rod
66 drive wheel
67 second end of locking rod
68 cap on well assembly
69 locking rod
70 rail assembly
71 track
72 bottom end
73 wall of building
74 top end
75 door
76 door handle
77 compression fitting
78 nipple
79 hole in shutter panel
80 female recess in crank shaft
81 male form on drive shaft
82 collar with lock screw
83 second collar
84 mounting bracket tension bolt
85 mounting bracket second bolt
86 motor
87 batteries
88 switch
89 coupling
90 well opening

1. A drive and lock assembly for driving and locking a shutter panel of a window, the assembly comprising:
(a) a mounting for mounting the drive and lock assembly adjacent the window;
(b) a manually operable first drive assembly comprising a rotatable drive shaft and a drive wheel, the drive shaft extending through an upper end portion of the mounting, the drive wheel being rotatably attached to a first end of the drive shaft;
(c) a handle assembly, which is removably attached to a second, opposite end of the drive shaft; and
(d) a rail assembly comprising a slidable slide rail, the slide rail being attachable to the shutter panel;
wherein rotation of the handle assembly rotates the drive shaft, which in turn rotates the drive wheel, which moves the slide rail, which slides the shutter panel.

2. The drive and lock assembly according to claim 1, further comprising a lock shaft, the lock shaft being transversely extendible through a corresponding hole in the mounting for maintaining the shutter panel in a closed position or an open position.

3. The drive and lock assembly according to claim 1, wherein one rotation of a rotatable handle of the handle assembly equals one rotation of the rotatable drive wheel.

4. The drive and lock assembly according to claim 2, wherein the first rail assembly further comprises a carrier rail that is generally L-shaped in transverse cross-section, the similarly shaped slide rail being inverted so that it movably engages the carrier rail, the slide rail being slidable along the carrier rail.

5. The drive and lock assembly according to claim 2, wherein the first drive assembly has two pivot points: a first pivot point between a spring-loaded lever arm and a stationary pivot arm of the drive and lock assembly, and a second pivot point between the lever arm and the lock shaft; the lever arm being pivotally attached to the stationary pivot arm, which projects from the mounting.

6. A drive and lock assembly for driving a shutter panel of a window, the drive and lock assembly comprising:
(a) a first rail assembly comprising a slidable slide rail, the slide rail being attachable to the window shutter panel;
(b) a first drive assembly comprising a rotatable drive shaft and a drive wheel, the rotatable drive wheel being attached to a first end of the drive shaft, the drive wheel contacting the slide rail; and
(c) a mounting bracket assembly for mounting the drive shaft, the drive shaft extending through an aperture in a mounting bracket of the mounting bracket assembly adjacent the drive wheel;
wherein the first drive assembly actuates movement of the drive wheel and therefore the slide rail, thereby moving the shutter panel between an open position and a closed position.

7. The drive and lock assembly according to claim 6, further comprising (d) a well assembly comprising a well, the well being attached to a second, well end of the drive shaft.

8. The drive and lock assembly according to claim 7, wherein the first rail assembly further comprises a carrier rail that is generally L-shaped in transverse cross-section, the similarly shaped slide rail being inverted so that it movably engages the carrier rail, the slide rail being slidable along the carrier rail.

9. The drive and lock assembly according to claim 8, further comprising (e) a removable handle assembly comprising a handle, a portion of the handle assembly being closely insertable in the well; wherein rotation of the handle actuates rotation of the drive shaft, which in turn causes the drive wheel to rotate, which moves the slide rail along the carrier rail, which slides the shutter panel.

10. The drive and lock assembly according to claim 9, wherein a slide rail first groove face of the slide rail is slidable on a carrier rail first groove face of the carrier rail, and the drive wheel contacts a slide rail top face of the slide rail.

11. The drive and lock assembly according to claim 10, wherein the carrier rail 11 is mounted to an exterior face of a building adjacent to the window shutter panel, and the slide rail is mounted to a rear face of the shutter panel.

12. The drive and lock assembly according to claim 7, wherein a substantial portion of the drive shaft is within a wall of a building on which the shutter panel is mounted, the shutter panel being on an exterior of the building wall, the well opening being accessible from an interior room of the building.

13. The drive and lock assembly according to claim 7, further comprising a removable locking rod that is insertable into the hollow drive shaft, a second end of the locking rod being extendible into or through a hole in the shutter panel.

14. The drive and lock assembly according to claim 12, wherein a first end of the locking rod is attached to a removable well cap, the well cap being insertable in an opening of the well, the locking rod being extendible through the well.

15. The drive and lock assembly according to claim 7, wherein the drive assembly is driven by a motor supported in the well.

16. The drive and lock assembly according to claim 7, wherein the mounting bracket assembly is attached to a frame of the window adjacent the shutter panel, and further comprises a mechanism for adjusting tension of the drive wheel.

17. The drive and lock assembly according to claim 9, wherein the removable handle assembly comprises a crank shaft, which is connected to a handle bar, the handle bar being connected to a handle, the crank shaft comprising a female recess closely corresponding to a male form on the end of the drive shaft.

18. The drive and lock assembly according to claim 17, the first drive assembly further comprising a second collar encircling the drive shaft between the male form and the mounting bracket for supporting the shaft and the drive wheel.

19. The drive and lock assembly according to claim 6, wherein a single rotation of the drive wheel moves the shutter panel about twice a distance equivalent to the diameter of the drive wheel.

20. The drive and lock assembly according to claim 16, wherein the mechanism for adjusting tension on the drive wheel is a mounting bracket tension bolt.
